(19) United States
(12) Patent Application Publication
(10) Pub. No.: US 2025/0130176 A1
(43) Pub. Date: Apr. 24, 2025

(54) Visual Inspection Systems for Containers of Liquid Pharmaceutical Products

(71) Applicant: AMGEN INC., Thousand Oaks, CA (US)

(72) Inventors: Thomas Clark Pearson, Newbury Park, CA (US); Graham F. Milne, Ventura, CA (US)

(21) Appl. No.: 18/835,139

(22) PCT Filed: Feb. 7, 2023
(86) PCT No.: PCT/US23/12458

§ 371 Date: Aug. 1, 2024

Related U.S. Application Data
(60) Provisional application No. 63/316,763, filed on Mar. 4, 2022.
(60) Provisional application No. 63/307,931, filed on Feb. 8, 2022.

(51) Int. Cl. G01N 21/88; G01N 21/958

(52) U.S. Cl. CPC G01N 21/8806; G01N 21/8851; G01N 21/958; G01N 2021/8848

(57) ABSTRACT

An automated visual inspection (AVI) system may include at least one profile view imager having an optical axis that passes through an inspection object, a proximal polarizing film axially aligned with the optical axis, a liquid crystal device axially aligned with the optical axis, a distal polarizing film axially aligned with the optical axis, and at least one light source oriented to emit illumination toward the distal polarizing film. Alternatively, or additionally, an AVI system may include a profile view imager having an optical axis that enters a container through a side wall of the container, and a ring light that is coaxially aligned with a central axis of the container, below the container, and oriented to emit light toward a bottom of the container. The AVI system may also include a bottom imager coaxially aligned with the central axis and oriented to view the bottom of the container.

### FIELD OF DISCLOSURE

The present application relates generally to visual inspection systems for inspection of containers of liquid pharmaceutical products, and more specifically to techniques for imaging containers/vessels of liquid pharmaceutical products without purposeful agitation of the liquid.

### BACKGROUND

In certain contexts, such as quality control procedures for manufactured drug products, it is necessary to examine samples (e.g., fluid samples) for the presence of various particles (e.g., protein aggregates or debris). The acceptability of a given sample, under the applicable quality standards, may depend on metrics such as the number and/or size of undesired particles contained within the sample. If a sample has unacceptable metrics, it may be rejected and discarded.

Similarly, inspection of the associated containers (e.g., vials, cartridges, syringes, vessels, seals, etc.) for the presence of various defects (e.g., vial seal bruises, cracks in the container, etc.) is necessary. Often times, different inspection systems (e.g., manual or automated visual inspection systems, etc.) are utilized for detection of different defects (e.g., presence of particles, presence of a particle resting on a bottom of a container, presence of a particle floating on a surface of a product within the container, container defects, product defects, etc.).

To handle the quantities typically associated with commercial production of pharmaceuticals, the particle and container inspection tasks have increasingly become automated. However, automated inspection systems have struggled to overcome various barriers to achieving good particle measurement and container fidelity void of system complexities. For example, liquid pharmaceutical products are often distributed in glass vials. Inspecting these glass vials for foreign particles and vial seal crimp defects is one of the most difficult challenges in an associated automated visual inspection (AVI) process. One reason for the difficulty with known AVI systems is that agitation of the liquid is needed to reliably detect particles. AVI systems that require agitation are highly dependent on, among other things, fluid properties and fill level of an associated liquid.

One known method for particle detection within a vial filled with a liquid, for example, involves spinning the vial fast (e.g., 1000-3000 RPM), and capturing a series of images as the vial spins. Heavy particles may be thrown against an inner surface of a sidewall of the vial due to centrifugal force. A silhouette of a particle may be detected from a series of images acquired from an imager while the vial is illuminated via a back light. An entire circumference of a vial may be inspected based on a series of images that are acquired from at least one stationary imager while the vial is spinning.

Another method for particle detection within a vial filled with a liquid, as another example, involves spinning the vial and abruptly stopping the vial from spinning (i.e., a “spin-stop” method). Multiple images are then captured of the vial while the fluid is still in motion. In the spin-stop method, image data associated with a subsequent image of a vial may be, for example, compared with respective image data associated with a preceding image of the vial, to deduce particle presence and optionally a particle time-series trajectory.

These known techniques for particle detection within a vial filled with a liquid may be good at detecting defects once the associated liquid is purposefully agitated. However, each method is highly dependent on several parameters, such as a vial spin speed, a vial spin deceleration rate, a fluid viscosity of a liquid within a vial, a product fill level within a vial, a fluid surface tension of a liquid within a vial, etc. Additionally, false rejects of the associated vials may be created by parameters, such as spin speed, deceleration rate, fluid viscosity, fill level, fluid surface tension, bubbles, surface defects on the glass, droplets of liquid forming on a neck area of the vial, from light reflected from other imager stations within an associated AVI system, etc.

While agitating a liquid in a vial may improve detection of some particles, over agitation of the liquid may result in agitation events, such as: bubbles forming within a vial, fluid droplets forming on a neck of the vial that look like a crack, etc. Due, at least in part, to the time required to optimize the spin and inspection parameters for a new product, the known techniques for particle detection within a vial filled with a liquid are not ideal for high mix-low volume (HMLV) production environment (e.g., clinical operations, small batches of product, etc.).

### SUMMARY

Embodiments described herein relate to systems and methods that improve upon conventional visual inspection techniques for containers (e.g., pharmaceutical vessels, vials, vessels, etc.) of liquid products. In particular, a system implementing the instant invention provides for imaging of a vessel containing a liquid, by capturing two-dimensional (2D) images using an automated visual inspection (AVI) system that does not purposefully rely on agitating the liquid within the vessel.

As described herein, an AVI system may include a profile view imager having an optical axis that passes through an inspection object (e.g., a container, a vessel, a vial, a syringe, a cartridge, etc.) that is at least partially translucent. The inspection object being positioned at a first distance from the profile view imager. The AVI system may also include a proximal polarizing film axially aligned with the optical axis, positioned at a second distance from the profile view imager, and oriented perpendicular to the optical axis. The second distance being less than the first distance. The AVI system may further include a liquid crystal device axially aligned with the optical axis, positioned at a third distance from the profile view imager, and oriented parallel to the proximal polarizing film. The third distance being greater than the second distance and less than the first distance. The AVI system may yet further include a distal polarizing film axially aligned with the optical axis, positioned at a fourth distance from the profile view imager, and oriented parallel to the proximal polarizing film and the liquid crystal device. The fourth distance being greater than the first distance. The AVI system may also include a light source oriented to emit illumination toward the distal polarizing film.

A computer-implemented method for imaging an inspection object may include emitting illumination from a light source. The method may also include polarizing the illumination emitted from the light source using a distal polarizing film. The method may further include transmitting the polarized illumination toward the inspection object, through a liquid crystal device, and through a proximal polarizing film. The method may yet further include capturing an image of the side wall of the inspection object with a profile view imager, the profile view imager having an optical axis that intersects the side wall of the inspection object.

Alternatively, or additionally, an automated visual inspection (AVI) system may include a profile view imager having an optical axis that enters a container through a side wall of the container. The container may be at least partially translucent. The AVI system may also include a ring light that is coaxially aligned with a central axis of the container, below the container, and oriented to emit light toward a bottom of the container.

The AVI system may further include a holding means for supporting and/or securing the container. As described herein, an AVI system may also include a bottom imager coaxially aligned with the central axis an oriented to view the bottom of the container. Alternatively, or additionally, the AVI system may include an optical axis reorientation mechanism to reorient an optical axis of an imager relative to a central axis of a container and/or an associated light source.

A computer-implemented method for imaging a container holding a liquid sample may include Illuminating the container with a ring light, the ring light is coaxially aligned with a central axis of the container, below the container, and oriented to emit light toward a bottom of the container. The method may also include capturing a profile view image with a profile view imager, the profile view imager having an optical axis that enters the container intersects a side wall of the container, the container being at least partially translucent.

Novel methods are provided for inspecting containers (e.g., vials, syringes, cartridges, etc.) for foreign particles or fibers, and/or other defects (e.g., damaged crimps, bruised seals, etc.) for high mix-low volume or other manufacturing environments based on captured images.

### BRIEF DESCRIPTION OF THE DRAWINGS

The skilled artisan will understand that the figures described herein are included for purposes of illustration and do not limit the present disclosure. The drawings are not necessarily to scale, and emphasis is instead placed upon illustrating the principles of the present disclosure. It is to be understood that, in some instances, various aspects of the described implementations may be shown exaggerated or enlarged to facilitate an understanding of the described implementations. In the drawings, like reference characters throughout the various drawings generally refer to functionally similar and/or structurally similar components.

FIGS. 1A and 1B depict various illustrations of an example automated visual inspection system having polarizing optical elements on opposite sides of an inspection object and between an imager and a light source.

FIG. 1C depicts the different states of a typical liquid crystal device.

FIG. 2 depicts another example automated visual inspection system having a ring light coaxially located with a central axis of a container and oriented to emit light toward a bottom of the container, along with an imager having an optical axis that enters the container through a side wall of the container.

FIG. 3 depicts a further example automated visual inspection system that combines the systems of FIGS. 1A, 1B, and 2 along with a bottom imager having an optical axis that is coaxial with the central axis and oriented to view a bottom of the container.

FIG. 4 depicts a yet a further example automated visual inspection system that combines a plurality of the systems of FIGS. 1A and 1B, along with a system of FIG. 3.

FIGS. 5A through 5C depict various example container types that may be inspected using a visual inspection system such as any of the visual inspection systems of FIGS. 1-4.

FIG. 6 is a simplified block diagram of an example system that may implement various techniques described herein relating to the training and/or use of one or more neural networks for automated visual inspection (AVI).

FIG. 7 depicts an example method of providing an AVI system that may be similar to the AVI system of FIGS. 1A and 1B or FIG. 2.

FIG. 8 depicts an example method of providing an AVI system that may be similar to the AVI system of FIG. 2, 3, or 4.

FIGS. 9A and 9B depict a bottom view of an example container that may be inspected using the system of FIG. 3 or 4.

FIGS. 10A and 10B depict a bottom view of another example container that may be inspected using the system of FIG. 3 or 4.

FIGS. 11A-14B depict profile views of example containers that may be inspected using any of the systems of FIGS. 1-4.

FIG. 15 depicts an example automated visual inspection method for detecting defects in a container using the systems of FIGS. 1-4 and 6.

### DETAILED DESCRIPTION

The various concepts introduced above and discussed in greater detail below may be implemented in any of numerous ways, and the described concepts are not limited to any particular manner of implementation. Examples of implementations are provided for illustrative purposes.

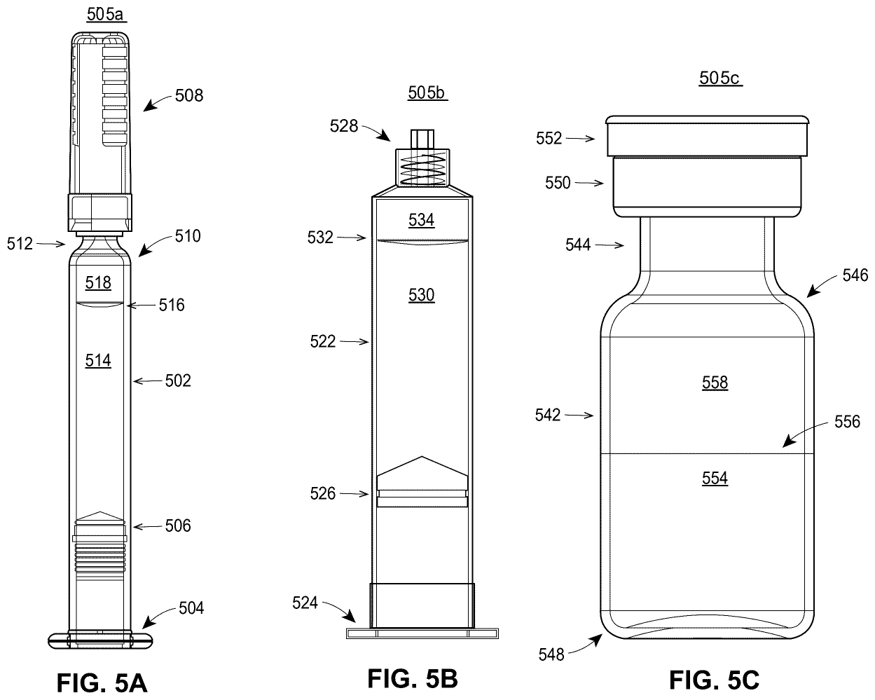

The automated visual inspection (AVI) systems of the present disclosure reduce complexities associated with inspecting containers (e.g., vial 505c of FIG. 5C, cartridge 505b of FIG. 5B, syringe 505a of FIG. 5A, etc.) that include a liquid product inside the container. For example, the AVI systems of the present disclosure may reduce, if not eliminate variables such as: a container spin speed, a container deceleration rate, a fluid viscosity of a product within a container, a product fill level within a container, a fluid surface tension of a product within a container, bubbles within a container, surface defects of container glass (or plastic, etc.), droplets of liquid forming on a neck area of a container, light reflected from other imager stations within an associated AVI system, etc. While embodiments are primarily described herein with reference to AVI systems, it is understood that various aspects may also be applied in manual visual inspection systems.

The AVI systems of the present disclosure may accommodate increased throughput speed of an associated inspection process compared to known systems. Additionally, or alternatively, the AVI systems may reduce time required to set up an automated inspection recipe for new products, making the AVI systems particularly useful for high-mix, low-volume production scenarios (e.g., clinical operations, small batches of product, etc.). Capturing images of a vial or other container without purposefully agitating a liquid product within the container, as described for certain embodiments herein, virtually eliminates the complexities that different fluid properties introduce when optimizing an associated inspection recipe.

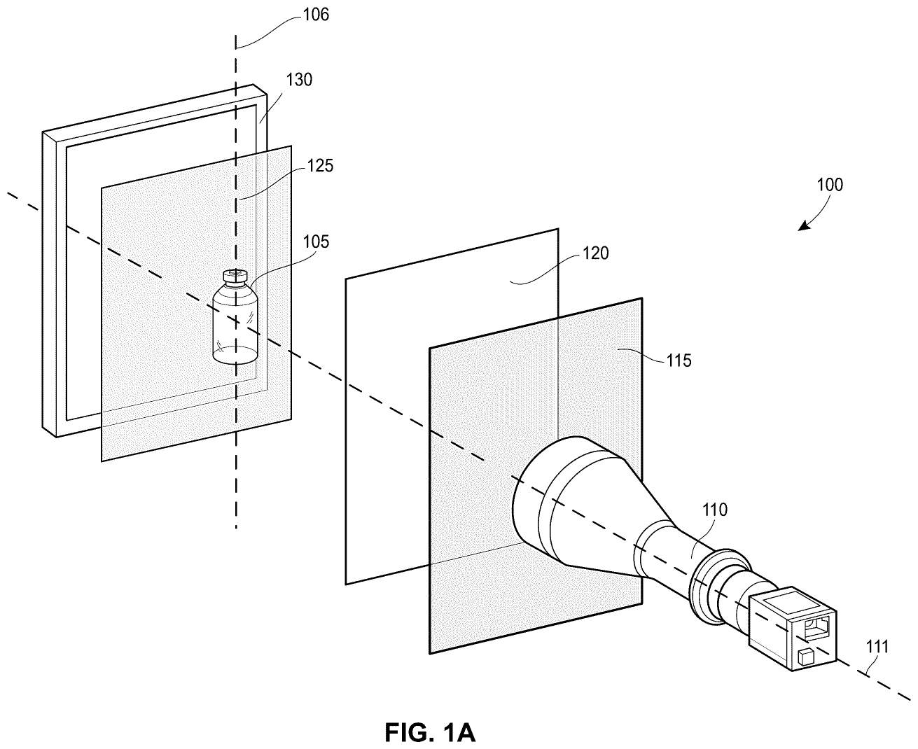

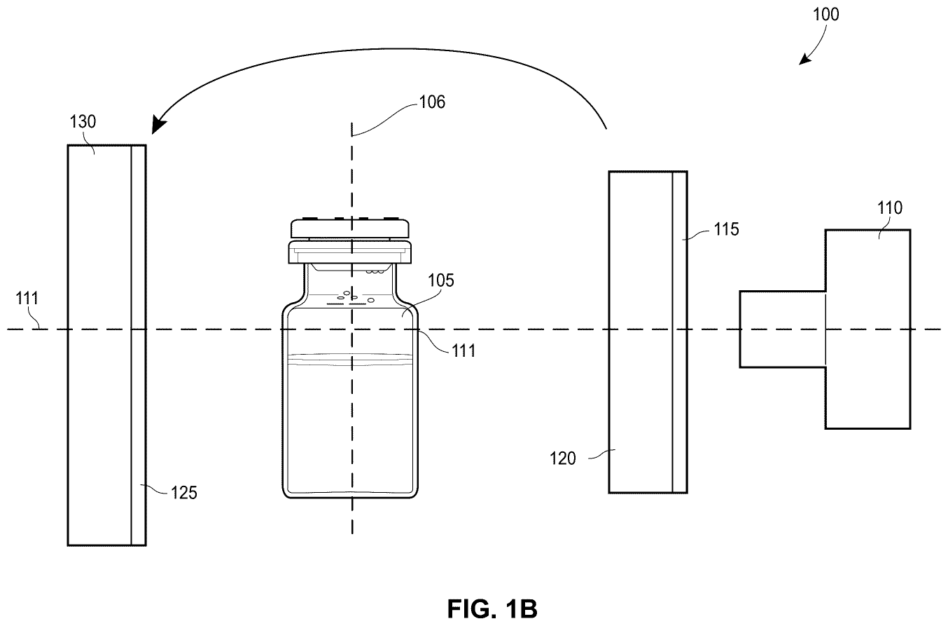

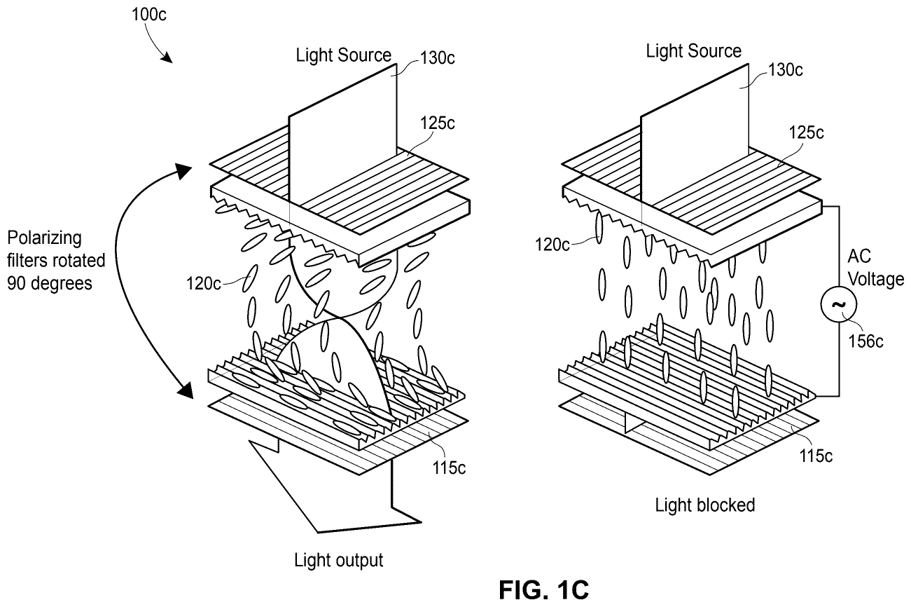

FIGS. 1A and 1B depict various illustrations of an example automated visual inspection (AVI) system 100 having polarizing optical elements 115, 125 on opposite sides of an inspection object 105 and between an imager 110 and a light source 130. An “imager” can be a camera (e.g., a CCD camera) alone, or including one or more external optical components (e.g., lenses, mirrors, etc.). Reference to an “optical axis” of an imager, as used herein, refers to an axis of an optical path of the imager in the region where the optical axis passes through an object being inspected (e.g., a container). Thus, for example, the use of a mirror may result in the “optical axis” of an imager being orthogonal to the central axis of a container, even if the imager itself is facing a direction that runs parallel to that central axis. A multitude of mirrors may be arranged around a container to combine various views of the container within a resultant field of view of a single imager 110.

An AVI system 100 may include a profile view imager 110 having an optical axis 111 that passes through an inspection object 105 that is at least partially translucent. While FIGS. 1A and 1B show that the inspection object 105 is a vial, the inspection object 105 may instead be a different type of translucent or partially translucent container (e.g., syringe 505a, cartridge 505b, etc.), or an object other than a container. The inspection object 105 is positioned at a first distance from the profile view imager 110. The AVI system 100a,b may also include a proximal polarizing film 115 axially aligned with the optical axis 111, positioned at a second distance from the profile view imager 110, and oriented perpendicular to the optical axis 111. The second distance is less than the first distance. The AVI system 100a,b may further include a liquid crystal device 120 axially aligned with the optical axis 111, positioned at a third distance from the profile view imager 110, and oriented parallel to the proximal polarizing film 115. The third distance is greater than the second distance and less than the first distance. The AVI system 100a,b may yet further include a distal polarizing film 120 axially aligned with the optical axis 111, positioned at a fourth distance from the profile view imager 110, and oriented parallel to the proximal polarizing film 115 and the liquid crystal device 120. The fourth distance is greater than the first distance. The AVI system 100a,b may also include a light source 130 oriented to emit illumination toward the distal polarizing film 125. A light source 130 may include at least one backlight, angled lighting, etc. As used herein, the relative terms “proximal” and “distal” denote spacing relative to an imager (e.g., profile view imager 110).

As used herein, reference to an object being “axially aligned” with a particular reference axis means that the object is positioned such that the reference axis intersects with, or passes through, the object. Of particular relevance to the AVI system 100a,b, because the proximal polarizing film 115, the liquid crystal device 120, the inspection object 105, and the distal polarizing film 125 are axially aligned with the optical axis 111 of the profile view imager 110, light emitted from the light source 130 passes through the distal polarizing film 125, the inspection object 105, the liquid crystal device 120, and the proximal polarizing film 115 before being received by the profile view imager 110. In some embodiments, the imager 110 is not a “profile view” imager. For example, elements 110, 115, and 120 may be positioned below a well containing a sample, and elements 125 and 130 may be positioned above the well (or vice versa).

The AVI system 100a,b may be particularly useful, however, for particle inspection in a vial or other container when using the arrangement shown in FIGS. 1A and 1B. While the profile view imager 110 is shown to be oriented horizontally, the imager 110 may instead be tilted up or down such that an optical axis 111 of the profile view image 110 is not perpendicular to a central axis 106 of the container 105 being imaged. For example, multiple imagers similar to profile view imager 110 may be oriented at different “elevation” angles such that an associated optical axis 111 is pointed slightly up or slightly down relative to the optical axis 111 shown in FIGS. 1A and 1B. This may be particularly useful to, for example, generate a composite three-dimensional image of the container 105 and its contents, from a plurality of two-dimensional images.

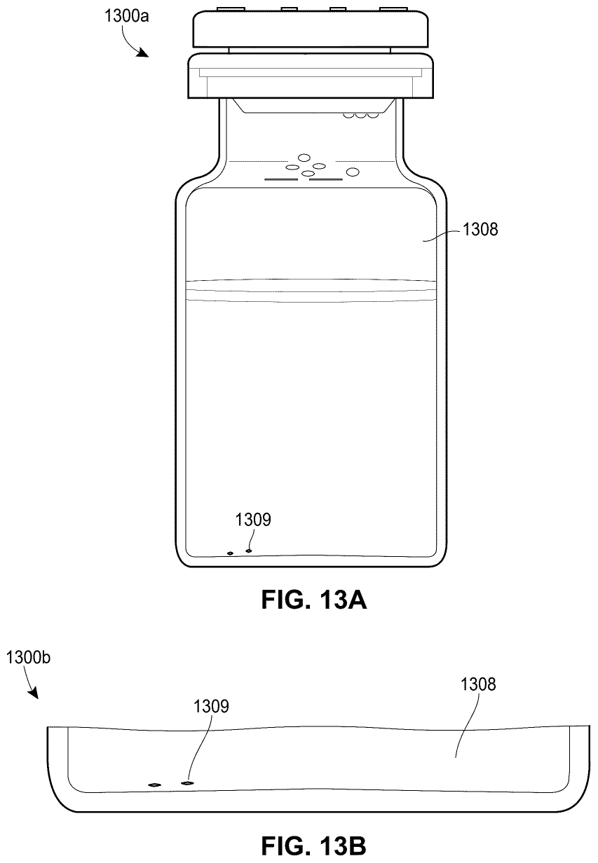

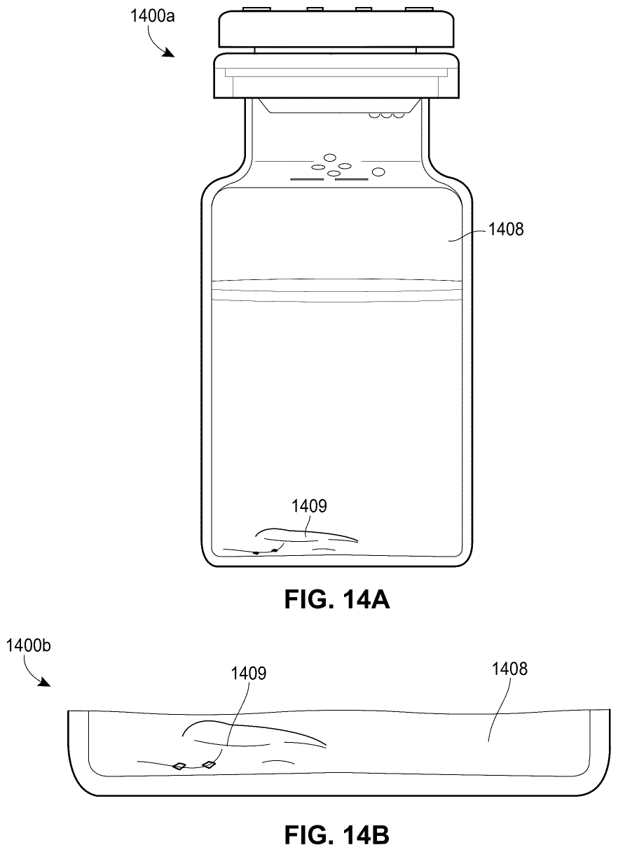

As illustrated in FIGS. 14A and 14B (relative to FIGS. 13A and 13B), detection of fibers 1409a,b may benefit from polarized films 115 and 125. The imager 110 may acquire images 1400a,b of FIGS. 14A and 14B when the light source 130 is energized and the liquid crystal device 120 is not energized. The imager 110 may acquire images 1300a,b of FIGS. 13A and 13B with the light source 130 and the liquid crystal device 120 both energized.

FIG. 1B illustrates modification of the liquid crystal device 100c by removing the polarizing filter 125c on the incoming side and placing the distal polarizing film 125 in from of the light source 130, so that the vial 105 is in-between the distal polarizing film 125 and the liquid crystal device 120 allows the polarizing affect to be switched on or off (by de-energizing or energizing the liquid crystal device 100c, respectively), allowing both filtered and unfiltered images to be captured. Accordingly, the AVI system 100a,b can electronically switch polarization on/off with no mechanical parts.

Other types of inspections, such as inspections for defects on a crimp and cracks in container glass, may be negatively impacted with polarizing filters in place. Thus, a liquid crystal device 120 can rapidly switch polarizing filters on or off, such that associated inspections can be performed at high speed with a minimal number of imagers (i.e., an image may be acquired with the liquid crystal device 120 energized, and another image may be acquired with the liquid crystal device 120 de-energized).

FIG. 1C illustrates typically constructed polarizing device 100c, and illustrates a functional diagram. The device 100c has two polarizing films 115c, 125c on each side of a liquid crystal cell 120c, and the distal polarizing film 125c is 90° out of phase with the proximal polarizing film 115c. An electrical charge 156c causes liquid crystals to align and keep the same polarization of light as what enters the device 100c. When not energized, the crystals rotate the light from the distal polarizing film 125c to being in phase with the proximal polarizing film 115c. In other words, when the liquid crystal device 100c is not energized, the device rotates the light 90 degrees. Whereas, when the liquid crystal device 100c is energized, the crystals align, and do not rotate the light. A typical liquid crystal device 100c may be used as an “electronic shutter,” as the device 100c includes polarizing film 115c, 125c on both sides of the cell 120c. This allows light to pass through when not energized and blocked when energized. Notably, the AVI system 100 1A and 1B may represent embodiments of a liquid crystal device 120c in which the filter 125c was removed and repositioned as illustrated in FIGS. 1A and 1B with distal polarizing film 125. While the liquid crystal device 100c is illustrated as a twisted nematic device, the device 100c may include any suitable cell 120c (e.g., a smectic cell, a cholesteric cell, etc.)

The AVI system 100a,b is particularly useful for applications where polarized light improves detection of specific types of defects, such as fibers (e.g., fibers 1409a,b of FIGS. 14A and 14B). On the other hand, when the liquid crystal device 120 is de-energized, other types of defects (e.g., defects in a seal crimp or cracks on the glass of the vial, etc.) may have less contrast with respect to background noise (e.g., bubbles, droplets, etc.). The polarization angle between light emitting from the light source and the light entering the imager 110 can be switched between zero degrees and 90 degrees polarization using a liquid crystal device 120.

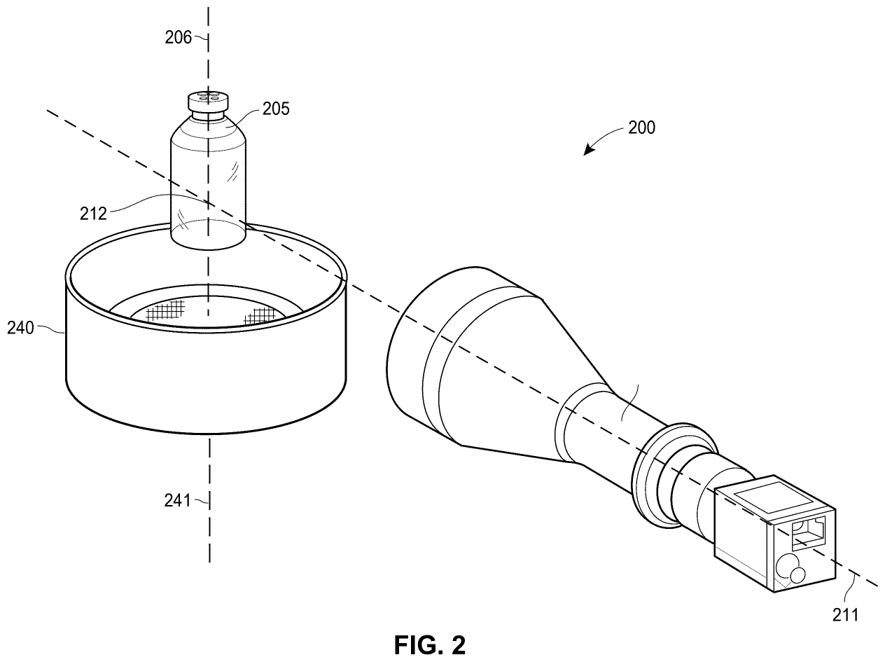

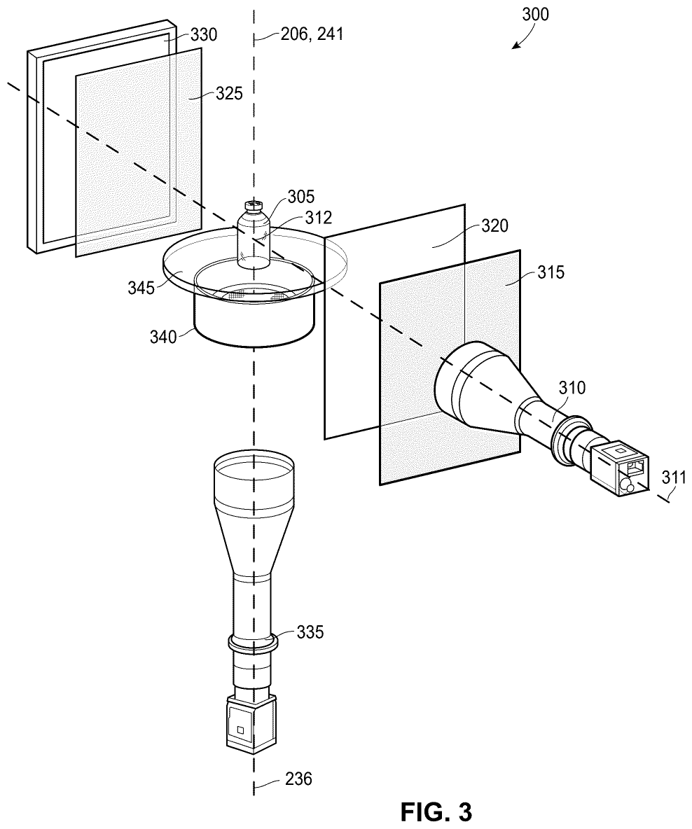

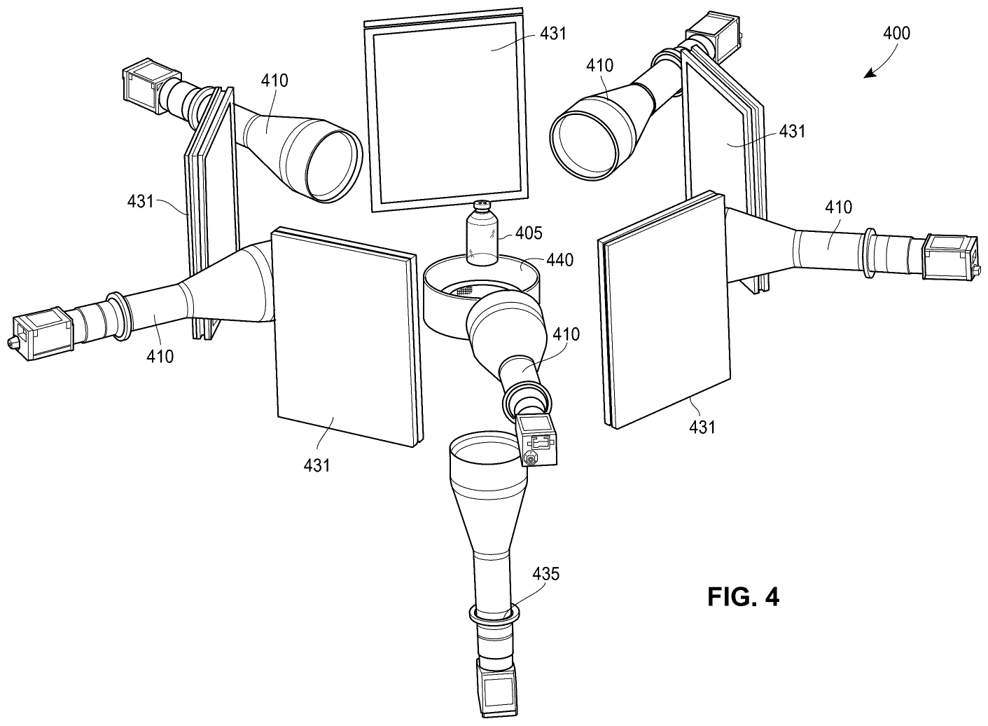

FIG. 2 depicts another example AVI system 200 in which a central axis 241 of a ring light 240 is coaxially aligned with a central axis 206 of a container 205, and oriented to emit light toward a bottom of the container 205. While FIG. 2 (as well as FIGS. 3 and 4) show that the container 205 is a vial, the container 205 may instead be a different type of translucent or partially translucent container (e.g., syringe 505a, cartridge 505b, vial 505c etc.). A profile view imager 210 has an optical axis 211 that enters the container 205 through a side wall 212 of the container 205. The AVI system 200 may further include a holding means (not shown in FIG. 2) for supporting and/or securing the container 205. Possible holding means are discussed in further detail below.

As used herein, reference to an object being “coaxially aligned” with a particular reference axis means that the object is positioned such that an axis of the object (e.g., its central axis 206) is substantially aligned with (substantially the same as) the reference axis. Of particular relevance in the AVI system 200, having the central axis 241 of the ring light 240 coaxially aligned with the central axis 206 of the container 205, light emitted from the ring light 240 may be projected evenly across a bottom and around a perimeter of the container 205.

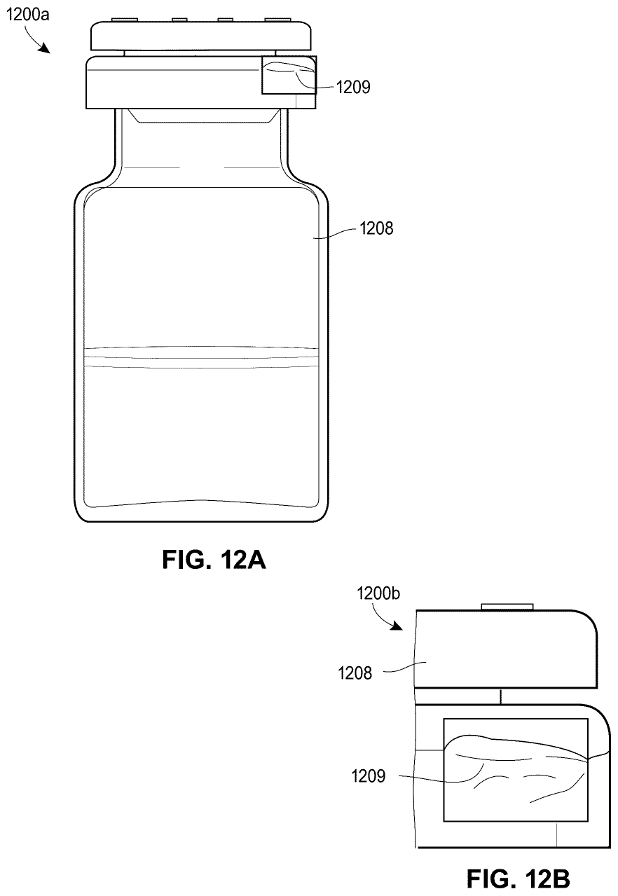

The AVI system 200 is particularly well suited to detecting vial crimp bruise defects. In fact, the ring lighting 240, typically set up for a bottom imager (e.g., bottom imager 335 of FIG. 3), is particularly useful for inspecting the crimp when an image (e.g., image 1200a,b of FIGS. 12A and 12B) is acquired from a profile view imager 210 with the right light 240 energized. Notably, bruise defects 1109a,b are among the most difficult defects to detect on the crimp 1208a,b when using conventional AVI setups. For example, conventional visual inspection systems may incur false rejects of a container due to shading differences in a container seal (i.e., the seal shading differences may appear as a bruise defect to a convention AVI system). The AVI system 200 may reduce false rejects of this sort.

Some of the same advantages to crimp detection (e.g., inspection speed, defect clarity, etc.) also apply for particle inspection. For example, an AVI system that does not purposefully agitate a liquid within a container may simplify AVI system setup for new container types and/or new products. Additionally, an AVI system that does not purposefully agitate a liquid within a container is not dependent on particle movement for particle detections. This is particularly advantageous when the container is inspected from multiple angles on the side profile as well as through a bottom of the container (e.g., AVI system 300 of FIG. 3). Other benefits of AVI system 200, such as lower variance of light and shadows, may improve identification of stationary particles.

FIG. 3 depicts a further example AVI system 300 that combines the systems of FIGS. 1A and 2, and further adds a bottom imager 335 having an optical axis 336 that is coaxially aligned with a central axis of a container 305, and oriented to view a bottom of the container 305. Without agitation, most particles tend to settle on a bottom of a vial and show with good contrast in images acquired from the bottom imager 335. The profile view imager 310 may be used to inspect for fibers and floating particles, as well as cracks, other defects in the glass, and the crimp area.

The AVI system 300 may be faster than a rotation-based inspection because there is no need to rotate a vial 305 (i.e., no ramp up, take photos, then ramp down), which can be a bottleneck in the AVI process. An AVI system 300 may alleviate the bottleneck issue, and may allow a closer to real-time AVI. The AVI system 300 may also result in faster set-up/programming because experimentation is not needed to determine which agitation speeds are excessive for different types of fluid/containers. Accuracy of the AVI system 300 can be very comparable to methods that include rotation-based techniques. AVI system 300 may detect glass and metal particles, as well as fibers, within a vial that contains a liquid product, for example.

The AVI system 300 may include a holding means 345 (e.g., a glass plate, a carousel, a starwheel, or a robotic arm that can rotate the container slowly, etc.) for supporting and/or securing the container 305. The holding means 345 may also function as an optical axis reorientation mechanism, which is described in more detail herein. The two imagers 310, 335, combined with different lighting arrangements (e.g., backlight 330 and ring light 340), can perform most of the inspections required of an automated visual inspection system 300. Fewer imagers and removing the need for agitation and fluid motion help reduce set up and characterization time for new products, which is generally a requirement for HMLV operations. Object detection using such the arrangement of AVI system 300 was found to detect all the particles and crimp defects with good success. Results indicate that detection rates are above that of manual inspection, 94% for 300 um metal particles, 100% for 1000 um metal, 85% for glass particles, and 92% for fibers, all with no false rejects (i.e., good samples being classified as defective). Conventional AVI equipment, as a comparison, may require agitation combined with over 10 different imagers to perform inspections.

FIG. 4 depicts a yet a further example AVI system 400 that is similar to AVI system 300, but uses additional profile view imagers. In the AVI system 200 or AVI system 300, some inspection processes, such as inspecting for vial crimp bruises, do require the vial to rotate slowly so that images around the perimeter of the container can be acquired from all profile perspectives. This can significantly slow down the inspection process. Placement of five profile view imagers 410 as in FIG. 4, however, allows inspection of an entire container 405 without any need to rotate the container 405. Accordingly, a series of images may be acquired by the plurality of profile view imagers 410, with each imager 410 having a different optical axis relative the container.

FIG. 4 shows a specific embodiment in which the need to rotate the container 405 is alleviated by placing five imagers 410 about the perimeter of the container 405. Five images taken about the perimeter of the container 405, or every 72 degrees, is sufficient to fully inspect the container 405 for particles and cracks or chips on the container side wall 412. However, other embodiments may include more (e.g., six) or fewer (e.g., four) profile view imagers 410. A multitude of mirrors may be arranged around the container 405 to combine various views of the container 405 within a resultant field of view of a single imager 410.

As seen in FIG. 4, the AVI system 400 may also include a bottom imager 435 coaxially aligned with the central axes of the container 405 and ring light 440, and oriented to view the bottom of the container 405.

The system 400 may include an optical axis reorientation mechanism (a plurality of imagers 410, each with a uniquely oriented optical axis) to change an orientation of the optical axis relative the side wall 412. The optical axis reorientation mechanism (a plurality of imagers 410, each with a uniquely oriented optical axis) may include a container rotator. Alternatively, or additionally, the optical axis reorientation mechanism may include a plurality of profile view imagers 410 each having a respective optical axis that passes through the side wall of the container about a perimeter of the container 405.

FIGS. 5A through 5C depict various example container types that, in certain pharmaceutical contexts, may be used as the samples imaged by visual inspection systems 100a,b of FIGS. 1A and 1B, visual inspection system 200 of FIG. 2, visual inspection system 300 of FIG. 3, or visual inspection system 400 of FIG. 4. Referring first to FIG. 5A, an example syringe 505a includes a hollow barrel 502, a flange 504, a plunger 506 that provides a movable fluid seal within the interior of barrel 502, and a needle shield 508 to cover the syringe needle (not shown in FIG. 5A). Barrel 502 and flange 504 may be formed of glass and/or plastic, and plunger 506 may be formed of rubber and/or plastic, for example. The needle shield 508 is separated by a shoulder 510 of syringe 505a by a gap 512. Syringe 505a contains a liquid (e.g., drug product) 514 within barrel 502 and above plunger 506. Typically, the top of liquid 514 forms a meniscus 516, above which is an air gap 518.

Referring next to FIG. 5B, an example cartridge 505b includes a hollow barrel 522, a flange 524, a piston 526 that provides a movable fluid seal within the interior of barrel 522, and a luer lock 528. Barrel 522, flange 524, and/or luer lock 528 may be formed of glass and/or plastic and piston 526 may be formed of rubber and/or plastic, for example. Cartridge 505b contains a liquid (e.g., drug product) 530 within barrel 522 and above piston 526. Typically, the top of liquid 530 forms a meniscus 532, above which is an air gap 534.

Referring next to FIG. 5C, an example vial 505c includes a hollow body 542 and neck 544, with the transition between the two forming a shoulder 546. At the bottom of vial 505c, body 542 transitions to a heel 548. A crimp 550 includes a stopper (not visible in FIG. 5C) that provides a fluid seal at the top of vial 505c, and a flip cap 552 covers crimp 550. Body 542, neck 544, shoulder 546, and heel 548 may be formed of glass and/or plastic, crimp 550 may be formed of metal, and flip cap 552 may be formed of plastic, for example. Vial 505c may include a liquid (e.g., drug product) 554 within body 542. Typically, the top of liquid 554 forms a meniscus 556 (e.g., a very slightly curved meniscus, if body 542 has a relatively large diameter), above which is an air gap 558. In other embodiments, liquid 554 is instead a solid material within vial 505c.

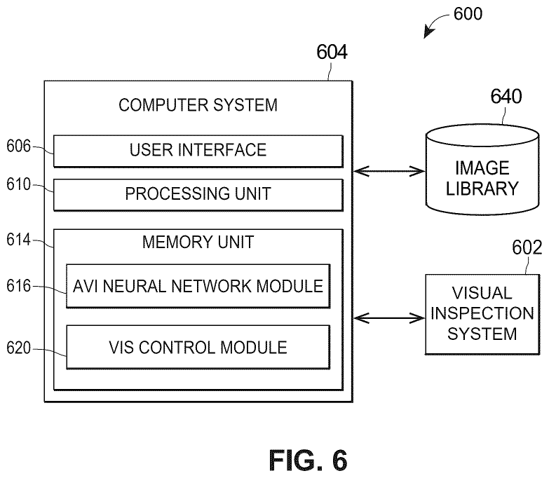

FIG. 6 is a simplified block diagram of an example system 600 that may implement various techniques relating to the training (and possibly validation and/or qualification) and/or use of one or more neural networks or other machine learning (ML) system. The system 600 could also be used to test/qualify non-ML AVI systems. In addition to, or as an alternative to, ML systems, the system 600 may include “computer vision” algorithms that do not use ML, but instead use fixed rules (e.g., empty vial, low fill, high fill, etc.).

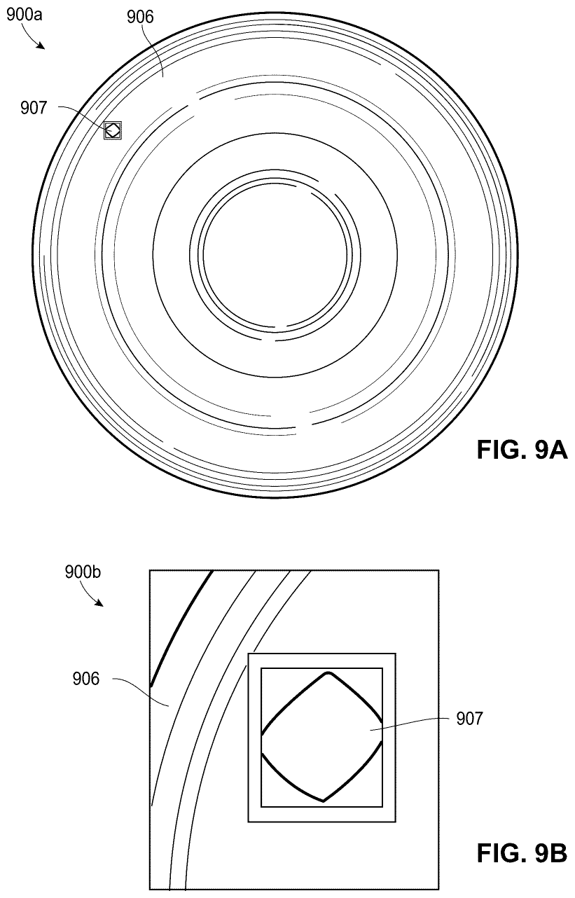

FIG. 6 shows an embodiment in which the system 600 implements one or more neural network(s). Once trained and qualified, the neural network(s) may be used in production to detect defects associated with containers and/or contents of those containers (e.g., defects shown in FIGS. 9A-14B). In a pharmaceutical context, for example, the neural network(s) may be used to detect defects associated with syringes, cartridges, vials or other container types (e.g., bruised crimps/seals, cracks, scratches, stains, missing components, etc., of the containers), and/or to detect defects associated with liquid or lyophilized drug products within the containers (e.g., the presence of fibers, metallic particles, and/or other foreign particles, variations in color of the product, etc.). As used herein, “defect detection” may refer to the classification of container images as exhibiting or not exhibiting defects (or particular defect categories), and/or may refer to the detection of particular objects or features (e.g., particles or cracks) that are relevant to whether a container and/or its contents should be considered defective, depending on the embodiment.

System 600 includes a visual inspection system (VIS) 602 communicatively coupled to a computer system 604. VIS 602 includes hardware (e.g., a conveyance mechanism, light source(s), imager(s), etc.), as well as firmware and/or software, that is configured to capture digital images of a sample (e.g., a container holding a fluid or lyophilized substance). VIS 602 may include any of the AVI systems 100a,b, 200, 300, 400 described herein respectively with reference to FIGS. 1-4, for example, or may be some other suitable system.

For ease of explanation, system 600 is described herein as training and validating one or more AVI neural networks using container images from VIS 602, and then using the trained/validated neural network(s) to perform AVI/defect detection. It is understood, however, that this need not be the case. For example, the system 600 may perform training and/or validation using container images generated by a number of different visual inspection systems instead of, or in addition to, VIS 602. Moreover, the training/validation may be performed by another system, and system 600 may then use the trained neural network(s) (e.g., during commercial production). In some embodiments, some or all of the container images used for training and/or validation are generated using one or more offline (e.g., lab-based) “mimic stations” that closely replicate important aspects of commercial line equipment stations (e.g., optics, lighting, etc.), thereby expanding the training and/or validation library without causing excessive downtime of the commercial line equipment.

VIS 602 may image each of a number of containers sequentially. To this end, VIS 602 may include, or operate in conjunction with, holding means such as a cartesian robot, carousel, starwheel and/or any other holding means that can successively move each container into an appropriate position for imaging, and then moves the container away once imaging of the container is complete. While not shown in FIG. 6, VIS 602 may include a communication interface and processors to enable communication with computer system 604. In other embodiments (e.g., lab-based setups), the VIS 602 includes simpler holding means (e.g., a stage with a hole covered by a glass plate).

Computer system 604 may generally be configured to control/automate the operation of VIS 602, and to receive and process images captured/generated by VIS 602, as discussed further below. Computer system 604 may be a general-purpose computer that is specifically programmed to perform the operations discussed herein, or may be a special-purpose computing device. As seen in FIG. 6, computer system 604 includes a user interface 606, a processing unit 610, and a memory unit 614. In some embodiments, however, computer system 604 includes two or more computers that are either co-located or remote from each other. In these distributed embodiments, the operations described herein relating to processing unit 610 and memory unit 614 may be divided among multiple processing units and/or memory units, respectively.

Processing unit 610 includes one or more processors, each of which may be a programmable microprocessor that executes software instructions stored in memory unit 614 to execute some or all of the functions of computer system 604 as described herein. Processing unit 610 may include one or more graphics processing units (GPUs) and/or one or more central processing units (CPUs), for example. Alternatively, or in addition, some of the processors in processing unit 610 may be other types of processors (e.g., application-specific integrated circuits (ASICs), field-programmable gate arrays (FPGAs), etc.), and some of the functionality of computer system 604 as described herein may instead be implemented in hardware.

Memory unit 614 may include one or more volatile and/or non-volatile memories. Any suitable memory type or types may be included in memory unit 614, such as read-only memory (ROM), random access memory (RAM), flash memory, a solid-state drive (SSD), a hard disk drive (HDD), and so on. Collectively, memory unit 614 may store one or more software applications, the data received/used by those applications, and the data output/generated by those applications.

Memory unit 614 stores the software instructions of various modules that, when executed by processing unit 610, performs various functions for the purpose of training, validating, and/or qualifying one or more AVI neural networks. Specifically, in the example embodiment of FIG. 6, memory unit 614 includes an AVI neural network module 616 and a visual inspection system (VIS) control module 620. In other embodiments, memory unit 614 may omit one or more of modules 616, 620 and/or include one or more additional modules. In addition, or alternatively, one, some, or all of modules 616, 620 may be implemented by a different computer system (e.g., a remote server coupled to computer system 604 via one or more wired and/or wireless communication networks). Moreover, the functionality of any one of modules 616 and 620 may be divided among different software applications and/or computer systems. As just one example, in an embodiment where computer system 604 accesses a web service to train and use one or more AVI neural networks, the software instructions of AVI neural network module 616 may be stored at a remote server.

AVI neural network module 616 comprises software that uses images stored in an image library 640 to train one or more AVI neural networks. Image library 640 may be stored in memory unit 614, or in another local or remote memory (e.g., a memory coupled to a remote library server, etc.). In addition to training, module 616 may implement/run the trained AVI neural network(s), e.g., by applying images newly acquired by VIS 602 (or another visual inspection system) to the neural network(s), possibly after certain pre-processing is performed on the images as discussed below. In various embodiments, the AVI neural network(s) trained and/or run by module 616 may classify entire images (e.g., defect vs. no defect, or presence or absence of a particular type of defect such as a crimp bruise or crimp defect generally, etc.), detect objects in images (e.g., detect the position of foreign objects that are not bubbles within container images), or some combination thereof (e.g., one neural network classifying images, and another performing object detection). As used herein, unless the context clearly indicates a more specific use, “object detection” broadly refers to techniques that identify the particular location of an object (e.g., a particle, a fiber, etc.) within an image, and/or that identify the particular location of a feature of a larger object (e.g., a bruised crimp or seal, a crack or chip on a syringe or cartridge barrel, etc.), and can include, for example, techniques that perform segmentation of the container image or image portion (e.g., pixel-by-pixel classification), or techniques that identify objects and place bounding boxes (or other boundary shapes) around those objects.

In embodiments where the AVI neural network(s) detect container defects, the defects may relate to any suitable container feature(s). Referring to the example containers of FIGS. 5A-5C, for instance, a particular AVI neural network implemented by the AVI neural network module 616 may detect whether barrel 502, barrel 522, or body 542 has a crack or stain, whether flange 504 or 524 is misshapen, whether needle shield 508 is not properly positioned, whether plunger 506 or piston 526 has any defects, whether luer lock 528 has any defects, whether crimp 550 is properly positioned and/or has any defects (e.g., bruising), whether flip cap 552 is properly positioned and/or has any defects, and so on.

Module 616 may run the trained AVI neural network(s) for purposes of validation, qualification, and/or inspection during commercial production. In one embodiment, for example, module 616 is used only to train and validate the AVI neural network(s), and the trained neural network(s) is/are then transported to another computer system for qualification and inspection during commercial production (e.g., using another module similar to module 616). In some embodiments where AVI neural network module 616 trains/runs multiple neural networks, module 616 includes separate software for each neural network.

As described above with respect to FIGS. 3, 4, ring lighting 340, 440 for the bottom imager 345, 435 is particularly useful to inspect for vial seal crimp defects (e.g., the vial seal crimp defect 1209 of FIGS. 12A and 12B). For example, a total of 100 images per container may be captured on 13 containers, resulting in 1300 images total. AVI neural network training may be performed on images from, for example, six vials after augmenting the associated training images by adjusting brightness, vertical mirroring, adding noise, and skewing the images, as well as skewing the bounding boxes (i.e., the training set may be multiplied fivefold). Generally, deep learning may be used to detect defects in the images. Use of previously trained AVI neural network(s) further reduces time required to set up an automated inspection recipe for new products. AVI neural networks of the present disclosure may be implemented for high-mix, low-volume production scenario such as clinical operations or small batches of product. then using modern deep learning techniques (e.g., AVI Neural network module 616 of FIG. 6).

In some embodiments, VIS control module 620 controls/automates operation of VIS 602 such that container images can be generated with little or no human interaction. VIS control module 620 may cause a given imager to capture a container image by sending a command or other electronic signal (e.g., generating a pulse on a control line, etc.) to that imager. VIS 602 may send the captured container images to computer system 604, which may store the images in memory unit 614 for local processing. In alternative embodiments, VIS 602 may be locally controlled, in which case VIS control module 620 may have less functionality than is described herein (e.g., only handling the retrieval of images from VIS 602), or may be omitted entirely from memory unit 614.

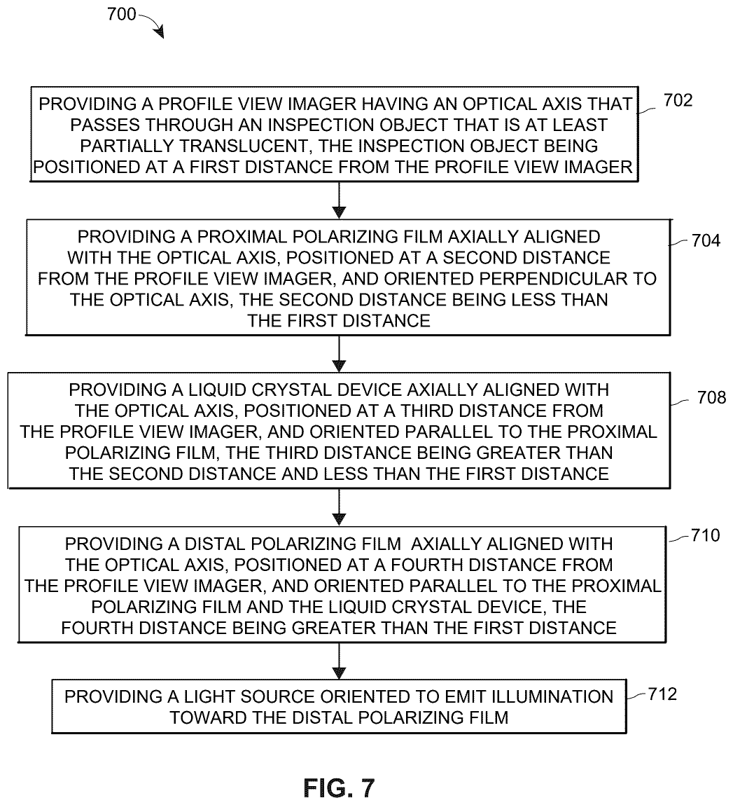

FIG. 7 is an example method 700 of operating an AVI system. The AVI system may be similar to, for example, the AVI system 100a,b of FIGS. 1A and 1B. The method may include providing a profile view imager 110 having an optical axis 111 that passes through an inspection object (e.g., a vial 105) that is at least partially translucent, the inspection object being positioned at a first distance from the profile view imager (block 702). A field of view of the profile view imager 110 may be configured to acquire a desired image of the inspection object (e.g., image 1100a, image 1200a, image 1300a, image 1400a, etc.), e.g., including the entire inspection object or just a portion thereof. The method 700 may also include providing a proximal polarizing film 115 axially aligned with the optical axis 111, positioned at a second distance from the profile view imager 110, and oriented perpendicular to the optical axis 111, the second distance being less than the first distance (block 704). The method 700 may further include providing a liquid crystal device 120 axially aligned with the optical axis 111, positioned at a third distance from the profile view imager 110, and oriented parallel to the proximal polarizing film 115, the third distance being greater than the second distance and less than the first distance (block 708). The method 700 may yet further include providing a distal polarizing film 125 axially aligned with the optical axis 111, positioned at a fourth distance from the profile view imager 110, and oriented parallel to the proximal polarizing film 115 and the liquid crystal device 120, the fourth distance being greater than the first distance (block 710). The method 700 may include a light source 130 oriented to emit illumination toward the distal polarizing film (block 712).

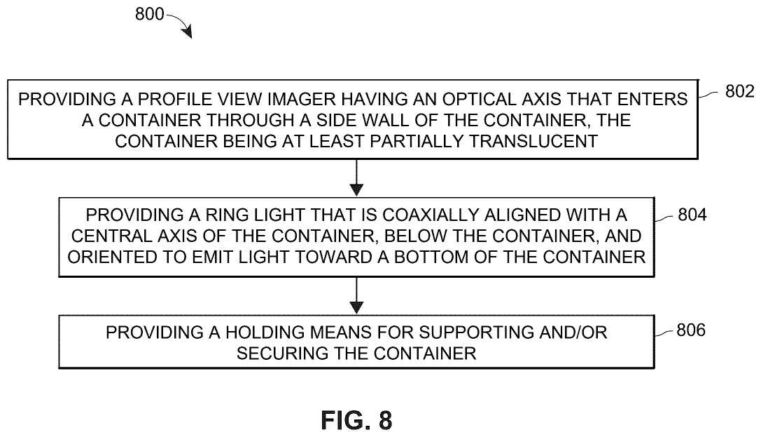

FIG. 8 is an example method 800 of operating an AVI system 800. The AVI system may be similar to, for example, the AVI system 200 of FIG. 2. The method 800 may include providing a profile view imager 210 having an optical axis 211 that enters a container (e.g., a vial 205) through a side wall of the container 205, the container being at least partially translucent (block 802). A field of view of the profile view imager 210 may be configured to acquire a desired image of the inspection object (e.g., image 1100a, image 1200a, image 1300a, image 1400a, etc.), e.g., including the entire inspection object or just a portion thereof. The method 800 may also include providing a ring light 240 that is coaxially aligned with a central axis 206 of the container 205, below the container, and oriented to emit light toward a bottom of the container (block 804). The method 800 may further include providing a holding means 245 for supporting and/or securing the container (block 806), as described elsewhere herein.

FIGS. 9A and 9B depict an image 900a,b (the latter being a zoomed-in view) of a bottom view of an example container 906 that may be inspected using the system of FIG. 3 (or FIG. 4 plus a bottom imager oriented in a manner similar to imager 335, 445 etc.). The bottom image 900a,b depicts a 1000 μm metal particle 907 imaged through the bottom of the container (here, a vial).

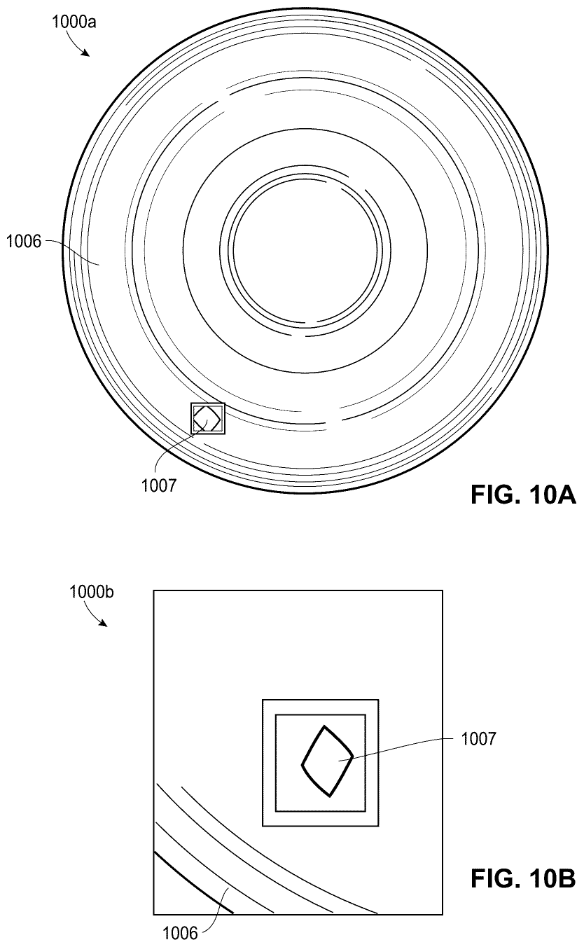

FIGS. 10A and 10B depict an image 1000a,b (the latter being a zoomed-in view) of a bottom view of another example container 1006 that may be inspected using the system of FIG. 3 (or FIG. 4 plus a bottom imager oriented in a manner similar to imager 335, etc.). The bottom image 1006a,b depicts a 300 μm metal particle 1007 imaged through the bottom of the container (vial).

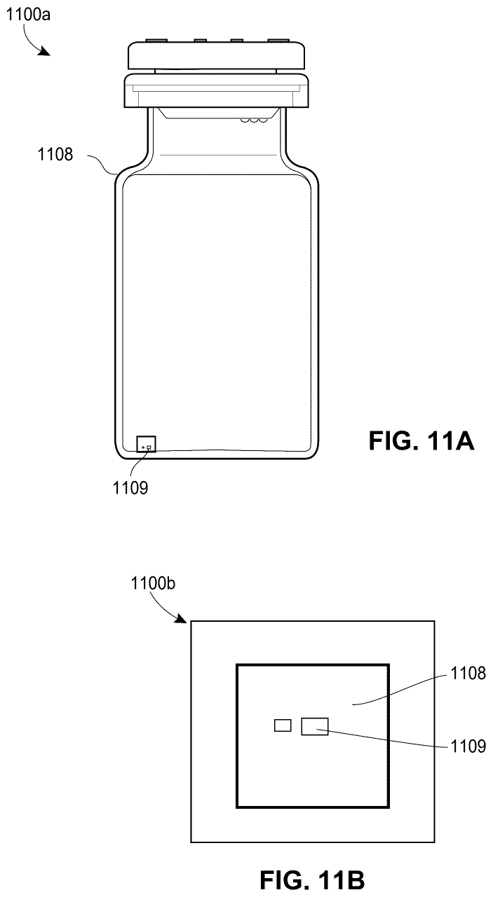

FIGS. 11A and 11B depict an image 1100a,b (the latter being a zoomed-in view) of a profile view of an example container 1108 that may be inspected using any of the systems of FIGS. 1-4. The profile view image 1100a,b depicts a fiber 1109 imaged through the side wall of the container (vial). The contrast of the fiber is improved by using polarizing films (e.g., polarizing films 115, 125 as arranged in FIG. 1A).

FIGS. 12A and 12B depict an image 1200a,b (the latter being a zoomed-in view) of a profile view of another example container 1208 that may be inspected using any of the systems of FIGS. 1-4. The profile view image 1108a,b depicts a bruised crimp 1209, with the box in FIG. 11B representing the output/result of object detection performed (e.g., by AVI neural network module 516) on the image 1200a,b from the profile view imager 110 and the liquid crystal device 120 switched off.

FIGS. 13A and 13B depict an image 1300a,b (the latter being a zoomed-in view) of a profile view of a further example container 1308b, which may be inspected using any of the systems of FIGS. 1-4 without a polarizing effect (e.g., liquid crystal device 120 switched on). When an image includes fluid droplets forming on a neck of the vial (e.g., the image of FIG. 13A), an associated AVI system may mistake edges of the fluid droplets as, for example, a crack in the associated container.

FIGS. 14A and 14B depict an image 1400a,b (the latter being a zoomed-in view) of the same profile view of the same example container 1408a,b as in FIGS. 13A and 13B, which may be inspected using any of the systems of FIGS. 1-4. Using a polarizing filter, a contrast ratio of the fiber 1409 with respect to the surroundings is higher than a contrast ratio of the fiber 1309 with respect to its surroundings. A neural network or other image processing of an AVI system is more likely to detect the fiber 1409 using the image 1400a,b of FIGS. 14A and 14B than detect the fiber 1309 using the image 1300a,b of FIGS. 13A and 13B.

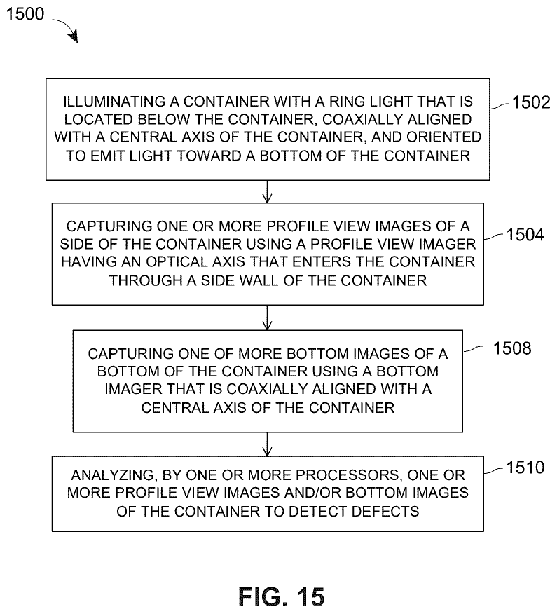

FIG. 15 depicts an example automated visual inspection method 1500 for detecting defects (e.g., particle 907, particle 1007, bruised seal 1109, fiber 1209, fiber 1309, etc.) in a container (e.g., syringe 505a, cartridge 505b, vial 505c, etc.). At least portions of the method 1500 may be implemented using, for example, any one of the systems of FIGS. 1-4 and 6. The method 1500 may include illuminating the container with a ring light (e.g., element 240, 340, or 440) that is located below the container, coaxially aligned with a central axis of the container, and oriented to emit light toward a bottom of the container (block 1502). The method 1500 may also include capturing one or more profile view images of a profile of the container using a profile view imager (e.g., imager 110, 210, 310, or 410) having an optical axis that enters the container through a side wall of the container (block 1504). A field of view of the profile view imager may be configured to acquire a desired image of the inspection object (e.g., image 1100a, image 1200a, image 1300a, image 1400a, etc.).

The method 1500 may further include capturing one of more bottom images of a bottom of the container using a bottom imager (e.g., imager 335 or 435) that is coaxially aligned with a central axis of the container (block 1508). A field of view of the bottom imager may be configured to acquire a desired image of the container (e.g., image 900a, image 1000a, etc.).

The method 1500 may also include analyzing, using one or more processors (e.g., processing unit 610 of FIG. 6 when executing the AVI neural network module 616), one or more profile view images (e.g., image 1100a, image 1200a, image 1300a, image 1400a, etc.) and/or one or more bottom images (e.g., image 900a, image 1000a, etc.) of the container to detect defects (block 1510). The processor(s) may implement one or more machine learning models (e.g., classification and/or object detection model(s)) to detect defects. For example, the processor(s) may implement a classification model to classify a container as “acceptable” or “reject.” Additionally, or alternatively, the processor(s) may implement multiple machine learning models to classify specific types of defects (e.g., a first machine learning model to classify a defect as a fiber within a container, a second machine learning model to classify a defect as a non-fiber particle within a container, a third machine learning model to classify a defect as a crimp bruise, etc.).

Although the systems, methods, devices, and components thereof, have been described in terms of exemplary embodiments, they are not limited thereto. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent that would still fall within the scope of the claims defining the invention.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. An automated visual inspection system, comprising:
a profile view imager having an optical axis that passes through an inspection object that is at least partially translucent, the inspection object being positioned at a first distance from the profile view imager;
a proximal polarizing film axially aligned with the optical axis, positioned at a second distance from the profile view imager, and oriented perpendicular to the optical axis, the second distance being less than the first distance;
a liquid crystal device axially aligned with the optical axis, positioned at a third distance from the profile view imager, and oriented parallel to the proximal polarizing film, the third distance being greater than the second distance and less than the first distance;
a distal polarizing film axially aligned with the optical axis, positioned at a fourth distance from the profile view imager, and oriented parallel to the proximal polarizing film and the liquid crystal device, the fourth distance being greater than the first distance; and
a light source oriented to emit illumination toward the distal polarizing film.

2. The system as in claim 1, wherein the inspection object is a container selected from a group including: a vial, a syringe, or a cartridge.

3. (canceled)

4. The system as in claim 1, further comprising:
(a) a ring light that is coaxially aligned with a central axis of the inspection object, below the inspection object, and oriented to emit light toward a bottom of the inspection object, (b) a bottom imager coaxially aligned with a central axis of the inspection object and oriented to view the bottom of the inspection object, (c) a container rotation mechanism, or (d) one or more additional profile view imagers oriented parallel with a respective optical axis to view at least a portion of a respective profile of the inspection object.

5. (canceled)

6. (canceled)

7. The system as in claim 4, comprising the one or more additional profile view imagers, wherein the one or more additional profile view imagers consist of four profile view imagers.

8. A method for imaging an inspection object that is at least partially translucent, the method comprising:
emitting illumination from a light source;
polarizing the illumination emitted from the light source using a distal polarizing film;
passing the polarized illumination through at least a portion the inspection object, then through a liquid crystal device, and then through a proximal polarizing film; and
capturing one or more images of the inspection object with a profile view imager, the profile view imager having an optical axis that intersects a side wall of the inspection object.

9. The method of claim 8, wherein the inspection object is a container selected from a group including: a vial, a syringe, or a cartridge.

10. (canceled)

11. The method of claim 8, further comprising:
analyzing, by one or more processors, the one or more images of the inspection object to detect at least one defect associated with the inspection object and/or contents of the inspection object.

12. The method of claim 11, wherein the at least one defect includes a particle or fiber within the container.

13. An automated visual inspection system, comprising:
a profile view imager having an optical axis that enters a container through a side wall of the container, the container being at least partially translucent;
a ring light that is coaxially aligned with a central axis of the container, below the container, and oriented to emit light toward a bottom of the container; and
a holding means for supporting and/or securing the container.

14. The system as in claim 13, further comprising:
at least one of: (a) a container rotator, (b) one or more additional profile view imagers oriented parallel with a respective optical axis to view at least a portion of a respective profile of the container, or (c) a bottom imager coaxially aligned with the central axis and oriented to view the bottom of the container.

15. The system as in claim 14, comprising the (b) one or more additional profile view imagers, wherein the one or more additional profile view imagers consist of four profile view imagers.

16. (canceled)

17. The system as in claim 13, further comprising:
a proximal polarizing film axially aligned with the optical axis, positioned at a second distance from the profile view imager, and oriented perpendicular to the optical axis, the second distance being less than a first distance between the container and the profile view imager;
a liquid crystal device axially aligned with the optical axis, positioned at a third distance from the profile view imager, and oriented parallel to the proximal polarizing film, the third distance being greater than the second distance and less than the first distance;
a distal polarizing film axially aligned with the optical axis, positioned at a fourth distance from the profile view imager, and oriented parallel to the proximal polarizing film and the liquid crystal device, the fourth distance being greater than the first distance; and
a light source oriented to emit illumination toward the distal polarizing film.

18. The system as in claim 13, further comprising:
a container rotator.

19. A method for imaging a container that is at least partially translucent and holds a liquid sample, the method comprising:
illuminating the container with a ring light, the ring light being coaxially aligned with a central axis of the container, below the container, and oriented to emit light toward a bottom of the container;
capturing one or more profile view images with a profile view imager, the profile view imager having an optical axis that enters the container through a side wall of the container: and
capturing one or more bottom images with a bottom imager coaxially aligned with the central axis and oriented to view the bottom of the container.

20. The method of claim 19, further comprising:
analyzing, by one or more processors, the (a) one or more profile view images of the container or (b) the one or more bottom images of the container, to detect at least one defect associated with the container and/or contents of the container.

21. The method of claim 20, wherein the at least one defect includes: (a) a particle or fiber within the container, or (b) a bruised container seal.

22. (canceled)

23. (canceled)

24. (canceled)

25. The method of claim 19, further comprising:
analyzing, by one or more processors, (a) one or more profile view images of the container or (b) the one or more bottom images of the container, to classify at least one defect associated with the container and/or contents of the container.

26. The method of claim 25, comprising analyzing, by one or more processors, the (a) one or more profile view images of the container, wherein the at least one defect associated with the container and/or contents of the container is classified as one of:
a particle within the container, a fiber within the container, or a bruised container seal.

27. (canceled)

28. The method of claim 25, comprising analyzing, by one or more processors, the (b) the one or more bottom images of the container, wherein the at least one defect associated with the container and/or contents of the container is classified as a particle within the container or a fiber within the container.

29. The method of claim 19, further comprising:
analyzing, by one or more processors, (a) the one or more profile view images of the container, or (b) the one or more bottom images of the container, to classify the container as either acceptable or a reject.

30. (canceled)

31. (canceled)
